(19) United States
(12) Patent Application Publication
(10) Pub. No.: US 2002/0189382 A1
(43) Pub. Date: Dec. 19, 2002

(54) Gear shifting mechanism

(76) Inventor: Huang-Yu Su, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/882,060

(22) Filed: Jun. 18, 2001

(51) Int. Cl. F16H 63/18

(52) U.S. Cl. 74/337.5

(57) ABSTRACT

A gear shifting mechanism includes a spindle, a drum shaft, a fork guide, a reverse shaft, and a main shaft, wherein the spindle is provided with a first gear, the drum shaft is provided with a drum, a second gear is mounted on each side of the drum, the first gear of the spindle is meshed with the second gear of said drum, said fork guide is provided with a fork having an end engaged with a sliding rail of said drum and another end engaged with a drum gear shift, and said drum gear shift is provided with a forward gear and a rear gear at two sides thereof, characterized in that said drum is sleeved over said drum shaft and two compression springs urge against two sides of the drum to keep the drum in place, thereby enabling the drum to slide on the drum shaft.

### BACKGROUND OF THE INVENTION

1. Field of the Invention

This invention is related to a gear shifting mechanism and in particular to one having a drum slidably mounted over a drum shaft and two compression springs urging against the drum in place thereby enabling a fork to move smoothly to a desired position on a sliding rail of the drum.

2. Description of the Prior Art

Referring to FIG. 1, the conventional gear shifting mechanism generally includes a spindle 1, a drum shaft 2, a fork guide 3 and a main shaft 4, wherein the drum shaft 2 has an integrally formed drum 21 provided at one side with a gear 22. A torque spring 23 is used for urging the gear 22 so as to keep it in place. The spindle 1 utilizes a gear 11 to mesh with the gear 22 of the drum 2. The fork guide 3 is provided with a fork 31 having an end engaged with the sliding rail of the drum 21 and the other end engaged with a drum gear shift 41 of the main shaft 4. When in operation, the spindle 1 is moved to rotate the drum 21 thereby causing an end of the fork 31 to move along the sliding rail of the drum 21 to the desired position. The other end of the fork 31 drives the drum gear shift 41 along the main shaft 4 to engage with the forward gear 42 or backward gear 43 thereby achieving the shifting purpose. This mechanism has long been used on sand buggies or motorcycles for people with disabilities. However, when the spindle 1 is moved to shift gears in order to drive the fork 31 to move the drum gear shift 41 toward the forward gear 42 or backward gear 43, the forward gear 42 or backward gear 43 is still thing so that the drum gear shift 41 will not be able to immediately engage with the recess 421 of the forward gear 42 or the recess 431 of the backward gear 43. The driver often has to wait until the forward gear 42 or the backward gear 43 rotates to the position where the drum gear shift 41 can be engaged with the recess 421 of the forward gear 42 or the recess 431 of the backward gear 43. Furthermore, since the drum 21 is integrally formed with the drum shaft 2 (the fork 31 is kept on the sliding rail of the drum 21 by the torsion spring 23), when the driver has moved the spindle 1 to the forward gear position or backward gear position but the drum gear shift 41 has not yet engaged with the forward gear 42 or backward gear 43, the fork 31 is not entered into the forward position 211 or backward position 212 on the sliding rail of the drum 21 thereby making it unable to shift gears smoothly.

Therefore, it is an object of the present invention to provide an improved gear shifting mechanism which can obviate and mitigate the above-mentioned drawbacks.

### SUMMARY OF THE INVENTION

This invention is related to an improved gear shifting mechanism.

It is the primary object of the present invention to provide a gear shifting mechanism which includes a spindle, a drum shaft, a fork guide, a reverse shaft, and a main shaft, wherein the spindle is provided with a first gear, the drum shaft is provided with a drum, a second gear is mounted on each side of the drum, the first gear of the spindle is meshed with the second gear of said drum, said fork guide is provided with a fork having an end engaged with a sliding rail of said drum and another end engaged with a drum gear shift, and said drum gear shift is provided with a forward gear and a rear gear at two sides thereof, characterized in that said drum is sleeved over said drum shaft and two compression springs urge against two sides of the drum to keep the drum in place, thereby enabling the drum to slide on the drum shaft.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a sectional view of a prior art gear shifting mechanism;

FIG. 2 is a sectional view of a gear shifting mechanism according to the present invention;

FIG. 3 is a sectional view illustrating that the gear shifting mechanism according to the present invention is shifted to the forward gear; and

FIG. 4 is a sectional view illustrating that the gear shifting mechanism according to the present invention is shifted to the backward gear.

### DETAILED DESCRIPTION OF THE PREFERRED EMBODIMENT

For the purpose of promoting an understanding of the principles of the invention, reference will now be made to the embodiment illustrated in the drawings. Specific language will be used to describe same. It will, nevertheless, be understood that no limitation of the scope of the invention is thereby intended, alterations and further modifications in the illustrated device, and further applications of the principles of the invention as illustrated herein being contemplated as would normally occur to one skilled in the art to which the invention relates.

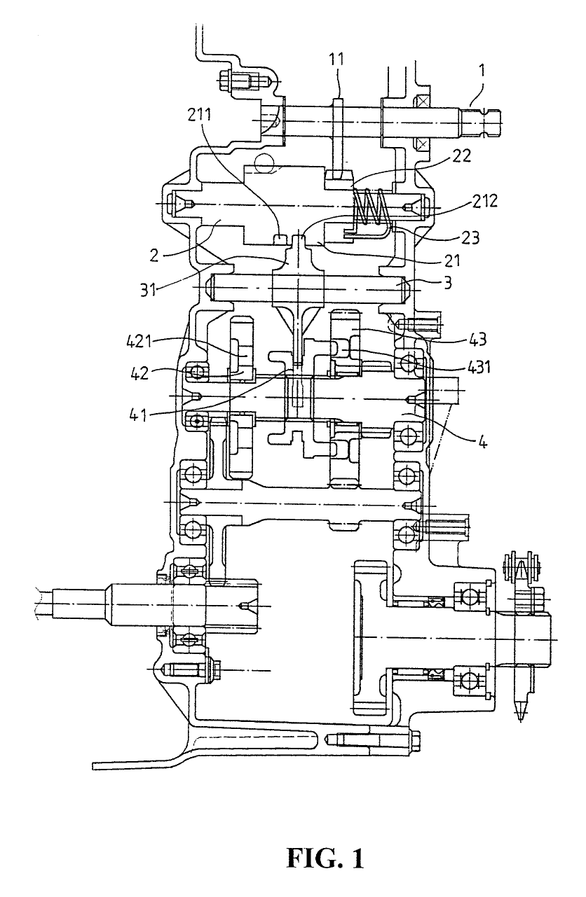

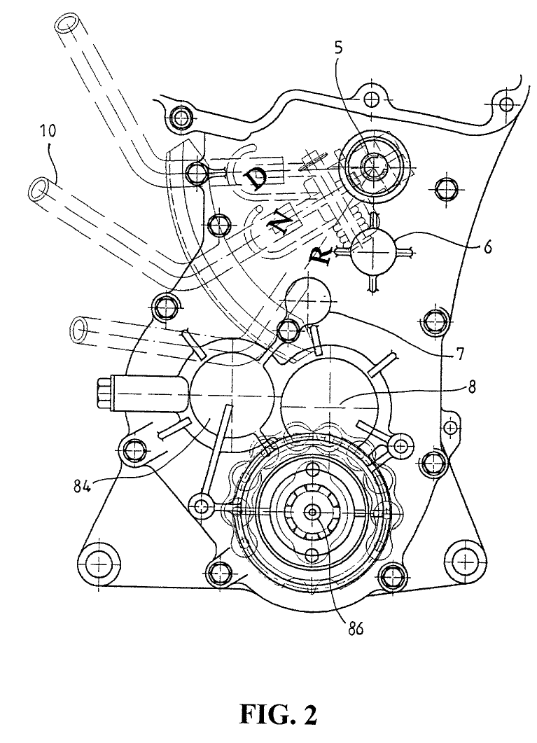

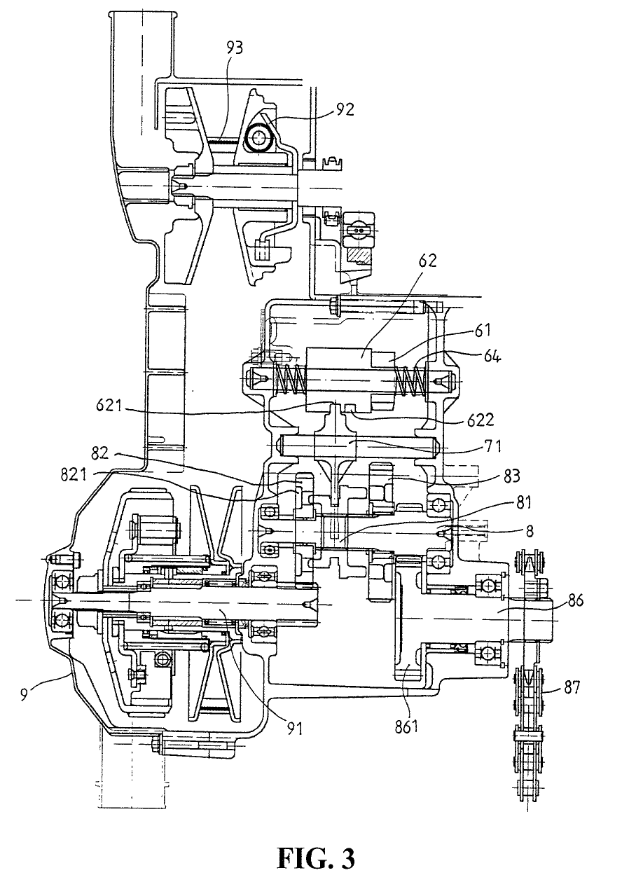

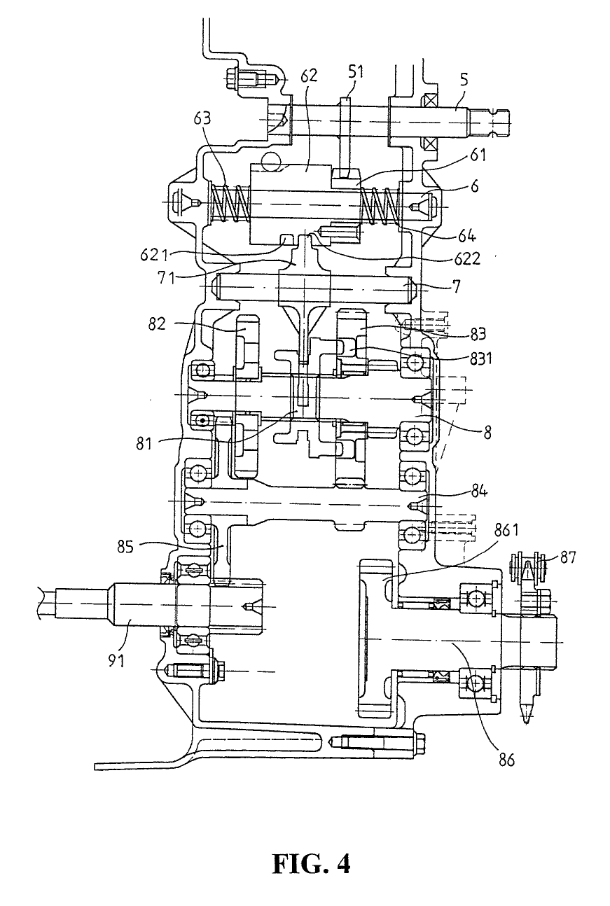

With reference to the drawings and in particular to FIGS. 1 and in particular to FIGS. 2 and 4, the gear shifting mechanism according to the present invention generally comprises a spindle 5, a drum shaft 6, a fork guide 7, a reverse shaft 84, and a main shaft 8. The spindle 5 is provided with a gear 51 which is meshed with a drum gear 61 mounted on the drum shaft 6. A drum 62 is sleeved over the drum shaft 6 so that the drum 62 can slide on the drum shaft 6. The drum 62 is urged by two compression springs 63 and 64 at two ends thereof The drum 62 has a sliding rail on which there are three positions: the forward position, the idle position and the backward position. The fork guide 7 is provided with a fork 71 having one end engaged with the sliding rail of the drum 62 and the other end engaged with a drum gear shift 81 which is slidably mounted on the main shaft 8. A forward gear 82 is mounted on the main shaft and located at one side of the drum gear shift 81. A backward gear 83 is mounted on the main shaft 8 and located at the other side of the drum gear shift 81. The backward gear 83 is meshed with an end of the reverse shaft 84. The other end of the reverse shaft 84 is provided with a conversion gear 85 which is meshed with an output shaft 91. Referring to FIG. 3, the forward gear 82 is meshed with the output shaft 91 and the main shaft 8 is meshed with a gear 861 on the final shaft 86 which is in turn connected to a wheel (not shown) via a chain 87.

As shown in FIG. 3, when the engine (not shown) is started, a driving disc 92 of the gear transmission 9 is driven to drive the output shaft 91 via a belt 93, which will then drive the forward gear 82. In the meantime, the backward gear 83 is driven via the gear 85 and the reverse shaft 84 (see FIG. 4). When desired to shift to go forward (see FIGS. 2 and 3), a control rod 10 is shifted from the neutral position to the forward position, the spindle 5 is moved to cause the gear 51 to drive the gear 61 there by rotating the drum 62. Then, the fork 71 is moved to the forward position 621 on the sliding rail of the drum 62. The drum 62 is forced to move rightward to compress the compression spring 64. Meanwhile, the other end of the fork 71 drives the drum gear shift 81 to move to the left along the main shaft 8, so that the drum gear shift 81 is engaged with recesses 821 of the forward gear 82 thereby causing the forward gear 82 to drive the main shaft 8 which in turn drives the gear 861 to rotate the final shaft 86 synchronously. Then, the chain 87 is driven to rotate the wheel.

Referring again to FIGS. 2 and 4, when desired to move backward, the operating rod 10 is shifted to the backward position thereby moving the spindle 5 to cause the gear 51 to drive the gear 61 and therefore rotating the drum 62. Then, the fork 71 is moved to the backward position 622 of the sliding rail of the drum 62. Hence, the drum 62 is moved to the left thus compressing the compression spring 63. In the meantime, the other end of the fork 71 drives the drum gear shift 81 to move to the right along the main shaft 8, so that the drum gear shift 81 moves rightward to engage with the recesses 831 of the backward gear 83. Thus, the backward gear 83 drives the main shaft 8 to rotate synchronously. Then, the main shaft 8 drives the gear 861 to rotate the final shaft 86 which in turn drives a chain 87 to rotate the wheel in a reverse direction.

As the drum 62 is sleeved over the drum shaft 6 and two compression springs 63 and 64 urging against drum 62 are used to keep the drum 62 in place, the drum 62 can slide on the drum shaft 6 in either direction. When desired to go forward, the fork 71 is moved to the forward position 621 so that the fork 71 pushes the drum gear shift 81 to engage with recesses 821 of the forward gear 82. Similarly, when desired to go backward, the fork 71 is moved to the backward position 622, the drum 62 will be forced to go to the left thereby compressing the compression spring 63 thereby causing the fork 71 to move smoothly to the backward position 622 of the drum 62 and therefore making the drum gear shift 81 engage smoothly with the recesses 831 of the backward gear 83.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A gear shifting mechanism comprising a spindle, a drum shaft, a fork guide, a reverse shaft, and a main shaft, wherein said spindle is provided with a first gear, said drum shaft is provided with a drum, a second gear is mounted on each side of the drum, said first gear of said spindle is meshed with said second gear of said dm, said fork guide is provided with a fork having an end engaged with a sliding rail of said drum and another end engaged with a drum gear shift, and said drum gear shift is provided with a forward gear and a rear gear at two sides thereof, characterized in that said drum is sleeved over said drum shaft and two compression springs urge against two sides of said drum to keep said drum in place, thereby enabling said drum to slide on said drum shaft.
